(19) United States
(12) Patent Application Publication
(10) Pub. No.: US 2019/0394290 A1
(43) Pub. Date: Dec. 26, 2019

(54) INFORMATION PUSH METHOD AND SYSTEM

(71) Applicant: Huizhou TCL Mobile Communication Co., Ltd., HuiZhou City (CN)

(72) Inventors: Zhaoyun Wu, HuiZhou City (CN); Xiurou Xiang, HuiZhou City (CN); Huixin Wang, HuiZhou City (CN); Shengpeng Liao, HuiZhou City (CN); Xinyao Ye, HuiZhou City (CN); Yajun Hu, HuiZhou City (CN); Longquan Yuan, HuiZhou City (CN); Hao Sun, HuiZhou City (CN)

(21) Appl. No.: 16/469,582

(22) PCT Filed: Dec. 7, 2017
(86) PCT No.: PCT/CN2017/115060

§ 371 Date: Jun. 13, 2019

(30) Foreign Application Priority Data
Dec. 13, 2016 (CN) 201611147968.2

(51) Int. Cl. H04L 29/08; H04W 4/021; H04W 88/04

(52) U.S. Cl. CPC H04L 67/26; H04L 67/18; H04W 88/04; H04W 4/021; H04L 67/141

(57) ABSTRACT

An information push method and system is provided. When a mobile terminal is detected to be within a preset range, a WiFi Aware apparatus transmits a WiFi Aware connection request to the mobile terminal. When the mobile terminal accepts the WiFi Aware connection request, the WiFi Aware apparatus and the mobile terminal are successfully connected, and the WiFi Aware apparatus actively pushes a message to the mobile terminal. Message automatic pushing is realized. Also, custom message filtering is realized in embodiments of the information push method and system.

### BACKGROUND

### 1. Technical Field

The present invention relates to WiFi Aware technologies, and more particularly, to an information push method and system.

### 2. Description of Related Arts

With development of mobile terminals, terminal apparatuses such as cell phones and tablets have become a primary channel to obtain various information. If users want to know the newest promotions, product information, or bus arriving information while they are located in public places such as bus stations, shopping malls, supermarkets, and restaurants, it has to connect the mobile terminals to a network and then manually retrieve the information. It brings a great deal of inconvenience for the users to connect to the network and then manually retrieve the information. How to automatically push messages to the mobile terminals becomes a feature trend of development.

### SUMMARY

The present invention provides an information push method and system, for solving the problem in the existing arts that information cannot be automatically pushed to a mobile terminal.

The technical schemes provided in the present invention are described below.

An information push method includes the steps of:

transmitting a WiFi Aware connection request to a mobile terminal in response to that the mobile terminal is detected by a WiFi Aware apparatus to be within a preset range; and

successfully connecting to the mobile terminal by the WiFi Aware apparatus and actively pushing a message to the mobile terminal by the WiFi Aware apparatus in response to that the mobile terminal accepts the WiFi Aware connection request.

In an embodiment of the information push method, after the step of successfully connecting to the mobile terminal by the WiFi Aware apparatus and actively pushing the message to the mobile terminal by the WiFi Aware apparatus in response to that the mobile terminal accepts the WiFi Aware connection request, the method further includes:

by the mobile terminal, analyzing the message received to obtain corresponding data, rendering an user interface based on the data, and displaying the user interface for a user.

In an embodiment of the information push method, after the step of by the mobile terminal, analyzing the message received to obtain the corresponding data, rendering the user interface based on the data, and displaying the user interface for the user, the method further includes:

setting how the data will be displayed and transmitting the setting to the WiFi Aware apparatus by WiFi Aware; and

by the WiFi Aware apparatus, storing the setting, and pushing a corresponding message to the mobile terminal based on the setting in response to that the mobile terminal is again detected to be within the preset range.

In an embodiment of the information push method, the preset range in the step of transmitting the WiFi Aware connection request to the mobile terminal in response to that the mobile terminal is detected by the WiFi Aware apparatus to be within the preset range refers to a circular coverage made by taking a position of the WiFi Aware apparatus as a center and a preset distance as a radius.

In an embodiment of the information push method, before the step of transmitting the WiFi Aware connection request to the mobile terminal in response to that the mobile terminal is detected by the WiFi Aware apparatus to be within the preset range, the method further includes:

presetting at least one WiFi Aware apparatus in a public place and monitoring in real time whether the mobile terminal appears within the preset range.

An information push system includes a WiFi Aware apparatus and a mobile terminal; the WiFi Aware apparatus, configured to transmit a WiFi Aware connection request to the mobile terminal in response to that the mobile terminal is detected to be within a preset range; and the mobile terminal, configured to accept the WiFi Aware connection request, and the WiFi Aware apparatus further configured to actively push a message to the mobile terminal in response to that the mobile terminal is connected to the WiFi Aware apparatus.

In an embodiment of the information push system, the mobile terminal is configured to analyze the message received to obtain corresponding data, render an user interface based on the data, and display the user interface for a user.

In an embodiment of the information push system, the system further includes a setting module, configured to set how the data will be displayed and transmit the setting to the WiFi Aware apparatus by WiFi Aware.

the WiFi Aware apparatus further configured to store the setting, and push a corresponding message to the mobile terminal based on the setting in response to that the mobile terminal is again detected to be within the preset range.

In an embodiment of the information push system, the preset range refers to a circular coverage made by taking a position of the WiFi Aware apparatus as a center and a preset distance as a radius.

In an embodiment of the information push system, the system further includes:

a monitoring module, configured to preset at least one WiFi Aware apparatus in a public place and monitor in real time whether the mobile terminal appears within the preset range.

The present invention further provides an information push method including the steps of:

presetting at least one WiFi Aware apparatus in a public place and monitoring in real time whether a mobile terminal appears within the preset range, wherein each WiFi Aware apparatus is preset with a corresponding preset range;

transmitting a WiFi Aware connection request to a mobile terminal in response to that the mobile terminal is detected by a WiFi Aware apparatus to be within a preset range; and

successfully connecting to the mobile terminal by the WiFi Aware apparatus and actively pushing a message to the mobile terminal by the WiFi Aware apparatus in response to that the mobile terminal accepts the WiFi Aware connection request.

In an embodiment of the information push method, after the step of successfully connecting to the mobile terminal by the WiFi Aware apparatus and actively pushing the message to the mobile terminal by the WiFi Aware apparatus in response to that the mobile terminal accepts the WiFi Aware connection request, the method further includes:

by the mobile terminal, analyzing the message received to obtain corresponding data, rendering an user interface based on the data, and displaying the user interface for a user.

In an embodiment of the information push method, after the step of successfully connecting to the mobile terminal by the WiFi Aware apparatus and actively pushing the message to the mobile terminal by the WiFi Aware apparatus in response to that the mobile terminal accepts the WiFi Aware connection request, the method further includes:

setting how the data will be displayed and transmitting the setting to the WiFi Aware apparatus by WiFi Aware; and

by the WiFi Aware apparatus, storing the setting, and pushing a corresponding message to the mobile terminal based on the setting in response to that the mobile terminal is again detected to be within the preset range.

In an embodiment of the information push method, the preset range in the step of transmitting the WiFi Aware connection request to the mobile terminal in response to that the mobile terminal is detected by the WiFi Aware apparatus to be within the preset range refers to a circular coverage made by taking a position of the WiFi Aware apparatus as a center and a preset distance as a radius.

The present invention provides the information push method and system. The wireless WiFi Aware apparatus is disposed in a public place. When the mobile terminal is detected to be within the preset range, the WiFi Aware apparatus transmits the WiFi Aware connection request to the mobile terminal. When the mobile terminal accepts the WiFi Aware connection request, the WiFi Aware apparatus actively pushes the message to the mobile terminal. The present invention realizes message automatic pushing and custom message filtering and has advantages of low cost, low power consumption, and high efficiency. The user does not have to connect to a network to query changes of certain information. Time is saved and convenience is provided for the user.

### BRIEF DESCRIPTION OF THE DRAWINGS

FIG. 1 is a flowchart of an information push method in accordance with a preferable embodiment of the present invention.

FIG. 2 is a structural block diagram showing an information push system in accordance with a preferable embodiment of the present invention.

### DETAILED DESCRIPTION

The present invention provides an information push method and system. To make the objectives, technical schemes, and effects of the present invention more clear and specific, the present invention is described in further detail below. It should be understood that the specific embodiments described herein are merely for explaining the present invention and the present invention is not limited thereto.

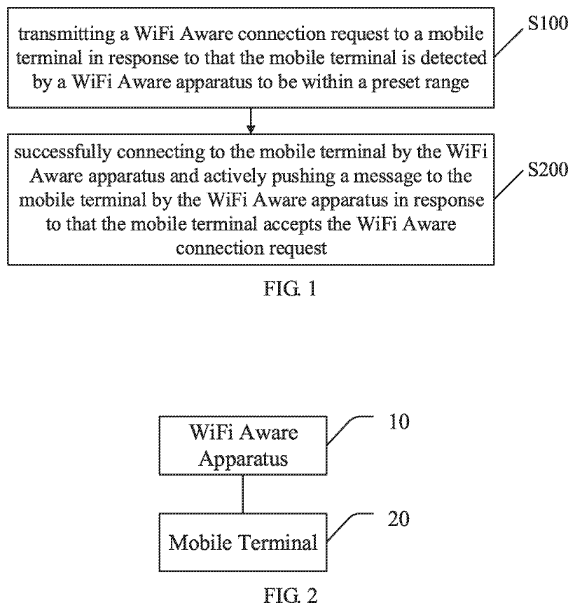

FIG. 1 is a flowchart of an information push method in accordance with a preferable embodiment of the present invention. As shown in FIG. 1, the method includes the following steps.

Step S100—transmitting a WiFi Aware connection request to a mobile terminal in response to that the mobile terminal is detected by a WiFi Aware apparatus to be within a preset range.

Step S200—successfully connecting to the mobile terminal by the WiFi Aware apparatus and actively pushing a message to the mobile terminal by the WiFi Aware apparatus in response to that the mobile terminal accepts the WiFi Aware connection request.

Specifically, a primary objective of embodiments of the present invention is to provide an information push method to solve problems in the existing arts. In the existing arts, when a user wants to know the newest promotions, product information, or bus arriving information in public places, it has to connect the mobile terminal to Internet and then manually query for the information, thereby bringing the user inconvenience with too much time cost.

To solve such a problem, the present invention provides a scheme to automatically push information based on WiFi Aware wireless technologies. Specifically, in the present invention, at least one WiFi Aware apparatus is preset in a public place and the WiFi Aware apparatus monitors in real time whether any mobile terminal appears within a preset range. Further, the preset range refers to a circular coverage made by taking a position of the WiFi Aware apparatus as a center and a preset distance as a radius.

That is, a distance threshold is set in the WiFi Aware apparatus. When a distance between the mobile terminal and the WiFi Aware apparatus is detected to be less than the distance threshold, the mobile terminal is determined to be within the preset range and the WiFi Aware apparatus transmits the WiFi Aware connection request to the mobile terminal.

In an embodiment, a plurality of WiFi Aware apparatuses may be disposed in public places. Each of the WiFi Aware apparatuses is set with a corresponding distance threshold. When a distance between the mobile terminal and each of the WiFi Aware apparatuses is detected to be less than the distance threshold, the WiFi Aware connection request is transmitted to the mobile terminal.

Preferably, in the present invention, a WiFi Aware connection sensing device may also be disposed in an access control system in public places. For example, when a user carrying the mobile terminal passes the access control checking and then enters a public place such as a shopping mall and a bus station, the mobile terminal will be detected by the WiFi Aware connection sensing device and the WiFi Aware apparatus disposed in the public place may establish a connection to the mobile terminal through the WiFi Aware connection sensing device.

Further, in Step S200, when the mobile terminal accepts the WiFi Aware connection request, the WiFi Aware apparatus successfully connects to the mobile terminal and actively pushes a message to the mobile terminal.

Specifically, when the WiFi Aware apparatus and the mobile terminal are successfully connected, the WiFi Aware apparatus actively pushes a message to the mobile terminal. After receiving the message pushed by the WiFi Aware apparatus, the mobile terminal utilizes a data processing module to analyze the message to obtain corresponding data, edit and organize the data, and render an user interface to display the data with the user interface for a user.

That is, the mobile terminal automatically receives the message transmitted by the WiFi Aware apparatus, organizes and edits the received message, and renders the user interface with needed data and presents it for the user, for ease of retrieving needed information quickly and conveniently for the user.

Further, in the present invention, after Step S200, the method further includes the followings.

Step S210—setting how the data will be displayed and transmitting the setting to the WiFi Aware apparatus by WiFi Aware.

Specifically, the WiFi Aware apparatus randomly provides the messages. When the messages involve too much classifications, it will bring inconvenience for the user to retrieve relevant information. For example, when the user enters the shopping mall, promotions actively sent by the WiFi Aware apparatus disposed in the shopping mall may involve various classifications such as clothes, shoes, food, movies, entertainment, and so on. If the user only wants to know promotions about clothes right now, it will bring a great deal of inconvenience for the user to retrieve relevant information among too much classifications. Accordingly, how the data will be displayed can be set in the present information. For example, it can be set that only the clothes promotions will be displayed. This setting will be transmitted by the mobile terminal to the WiFi Aware apparatus via Wifi Aware technologies.

Step S220—by the WiFi Aware apparatus, storing the setting, and pushing a corresponding message to the mobile terminal based on the setting in response to that the mobile terminal is again detected to be within the preset range.

Specifically, the WiFi Aware apparatus stored the setting received from the mobile terminal. When the mobile terminal is again detected to be within the preset range, a corresponding message will be pushed to the mobile terminal according to the setting. For example, if the setting is that only the clothes promotions are displayed, the WiFi Aware apparatus will then actively transmit the clothes promotions to the mobile terminal only. Accordingly, the present invention further has a function of custom filtering the messages.

Based on the afore-described method, the present invention further provides an information push system. As shown in FIG. 2, the system includes a WiFi Aware apparatus 10 and a mobile terminal 20. The WiFi Aware apparatus 10 is configured to transmit a WiFi Aware connection request to the mobile terminal in response to that the mobile terminal is detected to be within a preset range. The mobile terminal 20 is configured to accept the WiFi Aware connection request, and the WiFi Aware apparatus is further configured to actively push a message to the mobile terminal in response to that the mobile terminal is connected to the WiFi Aware apparatus.

In an embodiment of the information push system, the mobile terminal 20 is configured to analyze the message received to obtain corresponding data, render an user interface based on the data, and display the user interface for a user.

In an embodiment of the information push system, the system further includes a setting module, configured to set how the data will be displayed and transmit the setting to the WiFi Aware apparatus by WiFi Aware.

The WiFi Aware apparatus 10 is further configured to store the setting, and push a corresponding message to the mobile terminal based on the setting in response to that the mobile terminal is again detected to be within the preset range.

In an embodiment of the information push system, the preset range refers to a circular coverage made by taking a position of the WiFi Aware apparatus as a center and a preset distance as a radius.

In an embodiment of the information push system, the system further includes:

a monitoring module, configured to preset at least one WiFi Aware apparatus in a public place and monitor in real time whether the mobile terminal appears within the preset range.

Above all, the present invention provides the information push method and system. The wireless WiFi Aware apparatus is disposed in a public place. When the mobile terminal is detected to be within the preset range, the WiFi Aware apparatus transmits the WiFi Aware connection request to the mobile terminal. When the mobile terminal accepts the WiFi Aware connection request, the WiFi Aware apparatus actively pushes the message to the mobile terminal. The present invention realizes message automatic pushing and custom message filtering and has advantages of low cost, low power consumption, and high efficiency. The user does not have to connect to a network to query changes of certain information. Time is saved and convenience is provided for the user.

It should be understood that the application of the present invention is not limited to the above-described examples. Those of ordinary skill in the art may make modifications or variations according to the above descriptions, but all such modifications and variations should be within the appended claims.

1-14. (canceled)

15. An information push method, comprising the steps of:
transmitting a WiFi Aware connection request to a mobile terminal by a WiFi Aware apparatus in response to that the mobile terminal is detected by the WiFi Aware apparatus to be within a preset range;
successfully connecting to the mobile terminal by the WiFi Aware apparatus and actively pushing a message to the mobile terminal by the WiFi Aware apparatus in response to that the mobile terminal accepts the WiFi Aware connection request;
by the mobile terminal, setting how the message will be displayed and transmitting the setting to the WiFi Aware apparatus by WiFi Aware communication; and
by the WiFi Aware apparatus, storing the setting, and pushing a corresponding message to the mobile terminal based on the setting in response to that the mobile terminal is again detected to be within the preset range.

16. The method according to claim 15, wherein after the step of successfully connecting to the mobile terminal by the WiFi Aware apparatus and actively pushing the message to the mobile terminal by the WiFi Aware apparatus in response to that the mobile terminal accepts the WiFi Aware connection request, the method further comprises:
by the mobile terminal, analyzing the message received from the WiFi Aware apparatus to obtain corresponding data, rendering a user interface based on the data, and displaying the user interface.

17. The method according to claim 15, wherein the preset range refers to a circular coverage made by taking a position of the WiFi Aware apparatus as a center and a preset distance as a radius.

18. The method according to claim 15, wherein before the step of transmitting the WiFi Aware connection request to the mobile terminal in response to that the mobile terminal is detected by the WiFi Aware apparatus to be within the preset range, the method further comprises:
monitoring in real time whether the mobile terminal appears within the preset range.

19. An information push system, comprising:
a WiFi Aware apparatus, configured to transmit a WiFi Aware connection request to a mobile terminal in response to that the mobile terminal is detected to be within a preset range;
the mobile terminal, configured to accept the WiFi Aware connection request, and the WiFi Aware apparatus further configured to actively push a message to the mobile terminal in response to that the mobile terminal is connected to the WiFi Aware apparatus,
wherein the mobile terminal is further provided to set how the message will be displayed and transmit the setting to the WiFi Aware apparatus by WiFi Aware communication, and
wherein the WiFi Aware apparatus is further provided to store the setting, and push a corresponding message to the mobile terminal based on the setting in response to that the mobile terminal is again detected to be within the preset range.

20. The system according to claim 19, wherein the mobile terminal is further configured to analyze the message received from the WiFi Aware apparatus to obtain corresponding data, render a user interface based on the data, and display the user interface.

21. The system according to claim 19, wherein the preset range refers to a circular coverage made by taking a position of the WiFi Aware apparatus as a center and a preset distance as a radius.

22. The system according to claim 19, further comprising:
a monitoring module, configured to monitor in real time whether the mobile terminal appears within the preset range.

23. An information push method, comprising the steps of:
monitoring in real time whether a mobile terminal appears within a preset range;
transmitting a WiFi Aware connection request by a WiFi Aware apparatus to the mobile terminal in response to that the mobile terminal is detected by the WiFi Aware apparatus to be within the preset range;
successfully connecting to the mobile terminal by the WiFi Aware apparatus and actively pushing a message to the mobile terminal by the WiFi Aware apparatus in response to that the mobile terminal accepts the WiFi Aware connection request;
by the mobile terminal, analyzing the message received from the WiFi Aware apparatus to obtain corresponding data, rendering a user interface based on the data, and displaying the user interface;
by the mobile terminal, setting how the message will be displayed and transmitting the setting to the WiFi Aware apparatus by WiFi Aware communication; and
by the WiFi Aware apparatus, storing the setting, and pushing a corresponding message to the mobile terminal based on the setting in response to that the mobile terminal is again detected to be within the preset range.

24. The method according to claim 23, wherein the preset range refers to a circular coverage made by taking a position of the WiFi Aware apparatus as a center and a preset distance as a radius.
